(19) United States
(12) Patent Application Publication
(10) Pub. No.: US 2004/0059880 A1
(43) Pub. Date: Mar. 25, 2004

(54) Low latency memory access method using unified queue mechanism

(76) Inventor: Brian R. Bennett, Laguna Niguel, CA (US)

Correspondence Address: Michael J. Mallie, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/253,229

(22) Filed: Sep. 23, 2002

(51) Int. Cl. G06F 12/00

(52) U.S. Cl. 711/158; 711/154

(57) ABSTRACT

A memory access system, which includes a read request buffer to receive and reorder requests for memory access. The read request buffer reorders the request to skip a next request when that request is to be delayed. The buffer returns to the skipped request to process the request in a first-in first-out order. The system also includes a buffer allocator to supply buffer addresses for the memory access request, and a control logic to control the reordering of the request.

### BACKGROUND

The present invention relates to a control mechanism for optimizing memory access. More particularly, the present invention relates to using a single unified read request queue and special control logic to achieve relatively high bandwidth and low latency.

Several techniques have been used to improve memory access methods in large multi-processor systems. A typical approach is shown in FIG. 1, where incoming transactions 100 are decoded into ‘read-request-queue’ sequences 102. These decode sequences 102 are chosen so that the arbiter 102 selects the queues in order. This selection process has been determined to be an efficient method to avoid Row Address Strobe (RAS) pre-charge time (i.e. using device select or internal dynamic random access memory (DRAM) banks). However, one of the difficulties with the above-described technique is that the technique does not take into account the order of arrival of requests. Thus, using the conventional technique, transactions 100 may be processed in an order other than the order of arrival of requests. Sometimes the technique may be performed in such a way to cause a queue to be ‘skipped’ due to conflict and the next queue is processed so as to optimize memory bandwidth. Furthermore, in this case, the conventional technique may process the transactions by rotating from queue to queue with only limited knowledge of the receipt of the transactions. Therefore, the conventional technique has limited input knowledge in determining which queue to process next.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of a conventional memory access system using 4 separate memory read queues.

FIG. 2 is a block diagram of one embodiment of a memory access system using a unified queue and priority encoders.

FIG. 3 is a block diagram of one embodiment of an arbiter/control logic.

FIG. 4 is a block diagram of a current request generation logic.

FIG. 5 is a block diagram of one embodiment of a skip request generation logic.

FIG. 6 shows an example of a conventional approach to servicing memory read requests.

FIG. 7 shows an example of one embodiment of servicing memory read requests using the teachings described herein.

FIG. 8 is a tabulation of advantages of various embodiments described herein (lower latency, same throughput).

FIG. 9 is a resulting timing diagram of the example transaction sequence performed according to the process described in FIG. 7.

FIG. 10 is a block diagram of one embodiment of a memory access system using a time-stamp generator.

FIG. 11 illustrates a transaction processing sequence of a system having four read request queues and a time stamp generator.

FIG. 12 illustrates results of use of the memory access system of FIG. 10.

### DETAILED DESCRIPTION

In recognition of the above-stated difficulties associated with conventional memory access techniques, embodiments for improved memory access technique are described. Consequently, for purposes of illustration and not for purposes of limitation, the exemplary embodiments of the invention are described in a manner consistent with such use, though clearly the invention is not so limited.

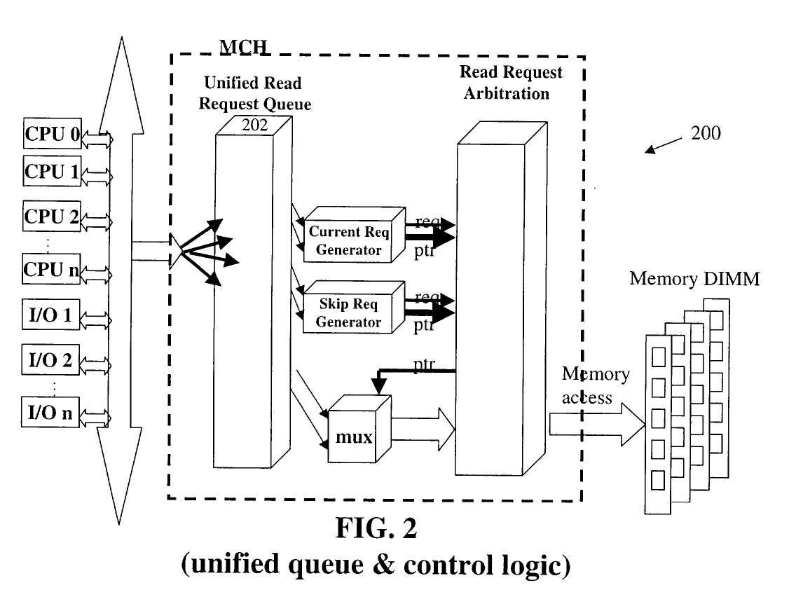

FIG. 2 is a block diagram of one embodiment of a memory access system 200. Referring to FIG. 2, the system 200 includes a unified read request queue 202 that receives and reorders transactions to ‘skip’ the next-in-line transaction if that transaction is to be delayed (e.g. due to RAS pre-charge). However, unlike the conventional system 100, the unified re-circulating buffers 202 of the memory access system 200 are configured to give priority to memory accesses on first-in-first-out order except during timing collisions when alternate selection of memory read requests may achieve higher throughput. Hence, after skipping a transaction, the unified queue 202 returns to the skipped transaction and attempts to process the transaction in a first-in first-out order.

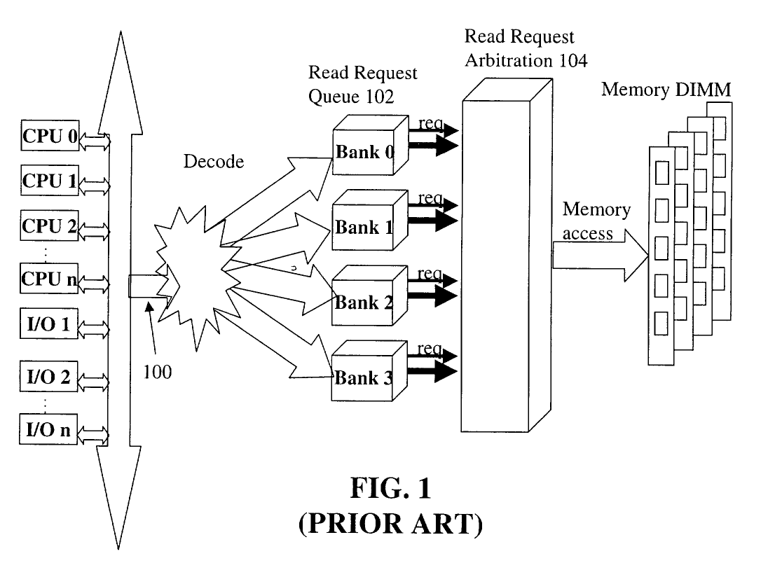

In the illustrated embodiment, the unified read request queue 202 assigns the buffer addresses in a linear assignment so that these buffer addresses maintain de facto time-stamp information that may later be processed by the rotating priority encoders. The linearly-assigned buffer addresses may then be processed by the control logic. Although the buffer addresses may be processed out of order, and may then be made “available” for reuse, the unified read request queue 202 may not reallocate these out-of-order buffers. This is done to maintain the time-order characteristic of the buffer addresses. Any such buffers are only temporarily “free” and not immediately reallocated for use. Hence, the use of a unified queue structure may overcome the problem associated with conventional, multi-queue structures that have the side effect of destroying any timing relationship between transactions in separate queues. Furthermore, the use of a single unified read request queue 202 may be more efficient because all queue entries may be used, and the entries are not “pre-dedicated” to certain transaction types, as in the case of 4 separate read request queues of FIG. 1.

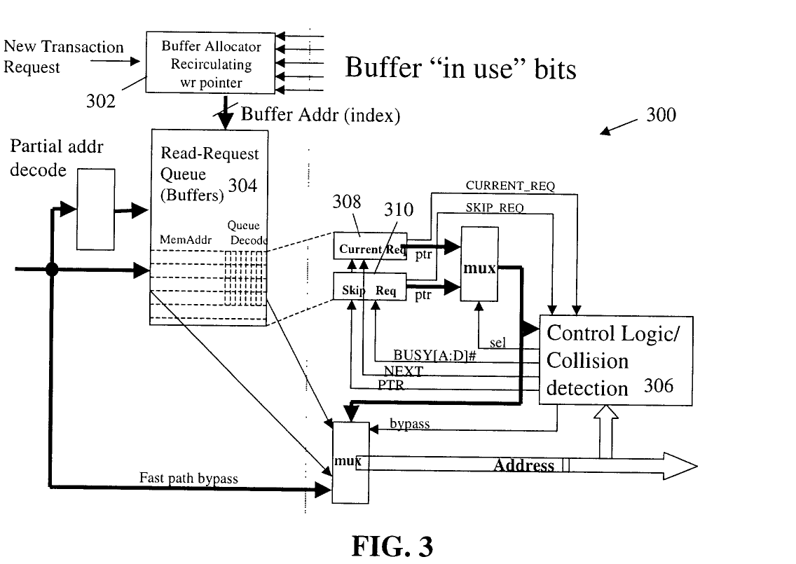

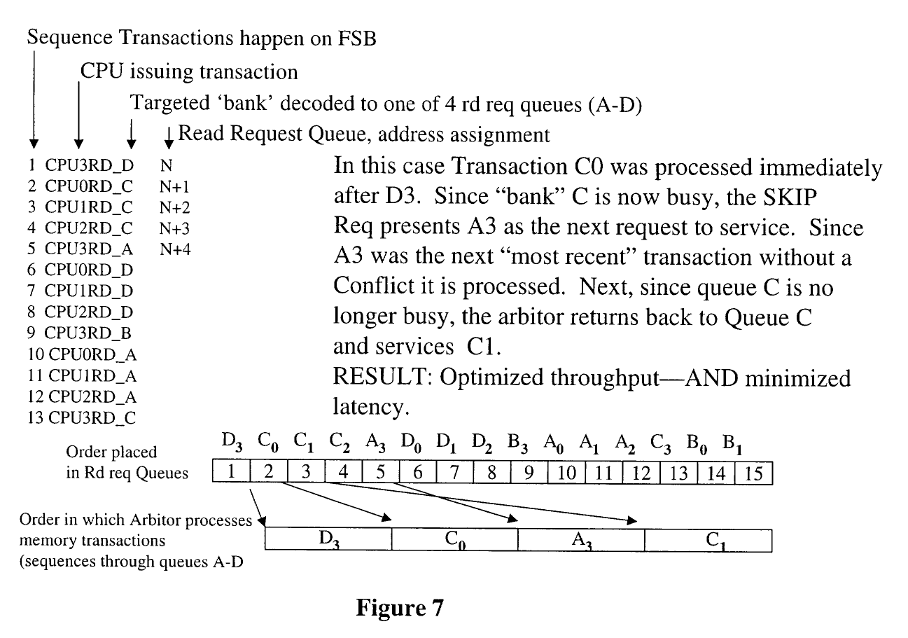

A more detailed block diagram of the memory access system 300 is shown in FIG. 3. In the illustrated embodiment, the memory access system 300 includes a buffer allocator 302, a read-request buffer 304, and control logic circuits 306. The read-request buffer 304 includes a current request encoder 308 and a skip request encoder 310. As shown in FIG. 3, the buffer allocator 302 supplies the buffer addresses for the transaction. These addresses are supplied in a strict linear order (see FIG. 7), which allows the buffer addresses to be used to determine “first in priority order” by the control logic circuits 306, 308, and 310. Status bits (not shown) mark buffers as Busy when written to, and cleared at the completion of the transaction. The read-request queue 304 also includes “Queue Decode Bits” corresponding to each memory address. The bits are determined by a queue mapping decode that reduces contention between queues (typically using bank select or DIMM select decodes). Each of the decode bits is mapped to the current request rotating priority encoder 308 and the skip request rotating priority encoder 310.

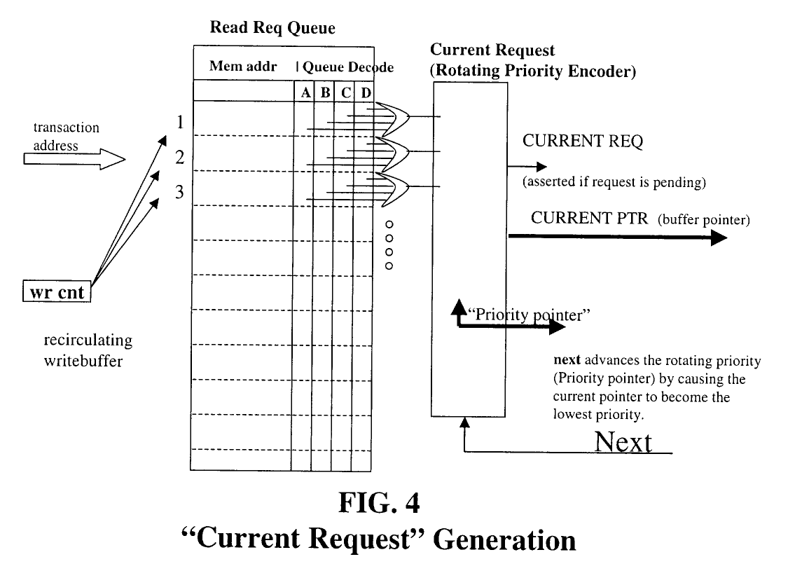

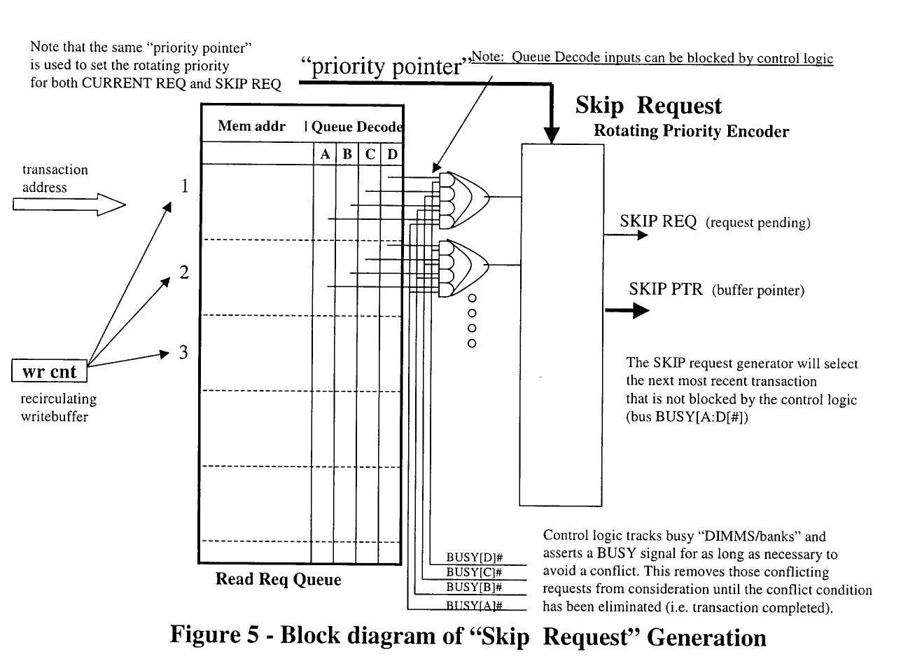

FIG. 4 illustrates control of the current request encoder 308 by the queue decode bits while FIG. 5 illustrates control of the skip request encoder 310 by the queue decode bits. These encoders 308, 310 post the highest priority “read request” to the control logic 306. The control logic 306 in turn uses these read requests to attempt to process the “current” request first and to skip to alternate requests only when a stall would otherwise be incurred (i.e. due to RAS pre-charge). The control logic 306 makes use of two rotating priority structures to obtain the ‘critically-ordered’ transaction for processing.

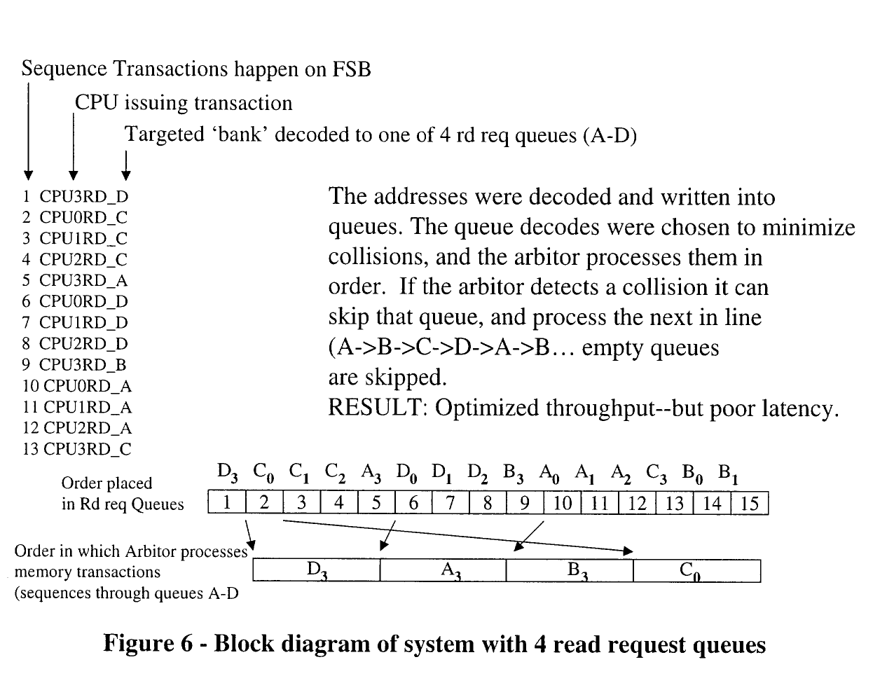

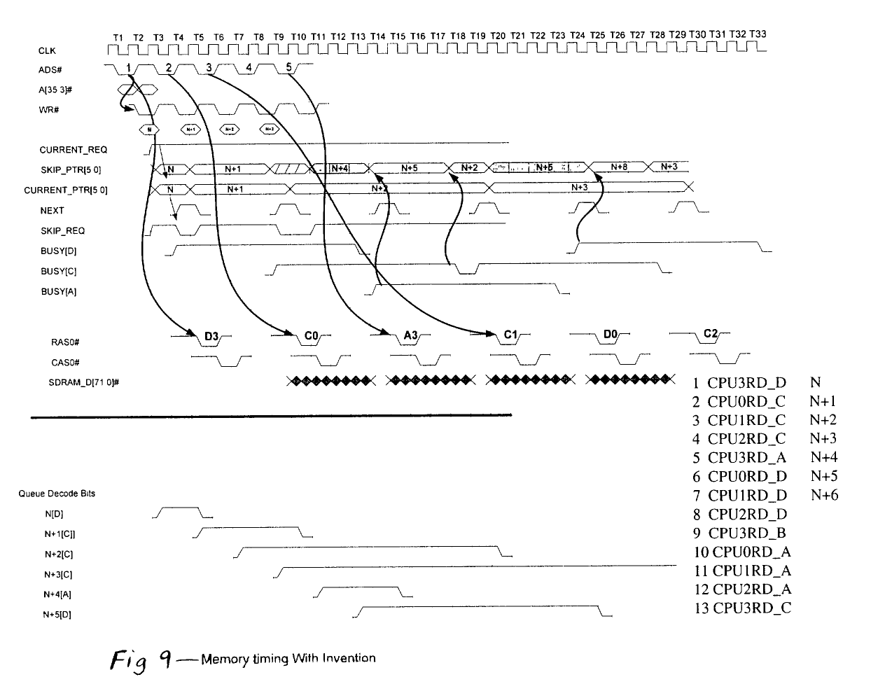

FIGS. 6 and 7 illustrate example transaction sequences for a conventional four read request queues design and a single unified read request queue design, respectively. FIG. 9 is a resulting timing diagram of the example transaction sequence performed according to the process described in FIG. 7.

Referring to FIG. 9, an incoming read transaction from CPU3 to bank D is initiated by the first front side bus (FSB) at T1. At T2, the read transaction is written into read request queue at entry address location N. Queue Decode bit D generated by partial decode logic is written along with the address. Subsequent transactions are written into locations N+1, N+2, N+3, . . . . As shown in FIG. 4, Queue Decode bit D, which is connected to priority encoders, causes CURRENT REQ (current request pending), to be asserted, and the buffer location N to be supplied to the control logic via CURRENT PTR, at T3. A second FSB transaction is initiated to bank “C”.

As shown in FIG. 3, control logic uses CURRENT PTR to index the Read Request Queue and read out address and decode bits, at T4. The control logic performs a check against any outstanding operations and if no conflict is detected and the read transaction is executed to external DRAM. Control logic asserts BUSY[D]# for as long as is needed to prevent another D Queue request from being requested while current D transaction is in process. The second FSB transaction is written into the buffer at location N+1.

Transaction CPU3RD_D is initiated to external DRAM with the assertion of RAS0, at T5. The control logic clears the Queue Decode bits for the current pointer (N) indicating that the read has been serviced (initiated). The control logic asserts NEXT signal causing the priority encoder to rotate so that the current request becomes the lowest priority request, and buffer entry at N+1 now contains the highest priority request.

The signal CURRENT REQ is now asserted due to the entry at N+1 (CPUORD_C). (Note also that the SKIP REQ has the same request pending). The control logic could read out the information at CURRENT REQ, check for a conflict, then if one exists, select and process the SKIP REQ. However, as an optimization, the control logic simply selects the SKIP REQ for processing. Once again the control logic reads out the address and queue decode bits. Since the SKIP REQ was selected the control logic does not have to check for conflict (Skip Request always contains the next time critical request with no conflict), the transaction CPUORD_C will be initiated to DRAM as soon as the next available DataBus slot is available (at T10). At T6-T8 additional FSB cycles are initiated and written into the buffer

Since the SKIP REQ was used, the control logic (see FIG. 3) does not automatically assert the NEXT signal (T9). The control logic compares the CURRENT PTR with the SKIP PTR. Since in this case they are equal, NEXT is asserted causing the priority encoder to rotate so that the current request becomes the lowest priority request. Simultaneous with NEXT assertion, the Queue Decode bits are cleared for buffer entry at SKIP POINTER (N+1). BUSY[C] # is asserted indicating that no new read cycles should be initiated to this DRAM bank.

RAS0 is asserted to start the DRAM access for CPU0RD_C, at T10. In response to NEXT assertion, the rotating priority encoder CURRENT_PTR advances to the next highest priority request which is at location N+2. The CURRENT REQ signal is now asserted due to the entry at N+2 (CPU1RD_C). Since the last transaction to bank “C” has not completed, a conflict is detected by the Control Logic when the current transaction(N+2) is compared to the in progress transactions. Since the last transaction to bank “C” has not completed (BUSY_C) still asserted, SKIP_REQ is not asserted for transaction N+4 (C1). In T10, there are no SKIP_REQ pending since there are no entries in the buffer that have not been processed, or that do not have conflicts. This is the first illustration of the usefulness of the SKIP_REQ. SKIP_REQ when asserted, points to the next time-critical ordered transaction that is guaranteed to not have any conflict (i.e., precharge). If it is not asserted, the controller can process from the CURRENT_REQ, and make allowance for any special timing requirements. In this case, the control logic will not start another transaction from either CURRENT_REQ or SKIP_REQ since there is no corresponding databus bandwidth slot available yet. As shown in FIG. 5, the SKIP₁₃ REQ assertion due to entries at N+2, N+3 will be blocked by the signal C_BUSY#. A write to the buffer at location N+4 occurs for the FSB transactions (CPU3RD_A).

The queue decode bit A is set from FSB transaction write in T10. This feeds into the SKIP REQUEST priority encoder and causes the SKIP REQ to be asserted for transaction CPU3RD_A and advances the SKIP PTR to N+4. The control logic processes the SKIP transaction (CPU3RD_A).

Since there is no databus bandwidth available no new transaction is started during these clocks (T12-T13). At T14, as before, the control logic compares the SKIP PTR to the CURRENT PTR and in this case they are not equal (versus N+5 versus N+2 respectively), hence it does not assert the NEXT signal. BUSY[A] is asserted causing SKIP PTR to advance to N+5.

Transaction CPU3RD_A is initiated (RAS asserted) and the control logic clears the respective Queue Decode bit which removes this transaction from the read request logic (T15). The transaction at CPURD0_C has now completed and BUSY[C]# has been deasserted, thus SKIP PTR changes now that transactions to bank C are not being blocked and generates a pointer for the next time-ordered transaction which is located at N+2 (T18). The control logic services this request. At the completion (T19), the control logic compares the SKIP PTR to the CURRENT PTR and they are equal. Hence in this case NEXT is asserted causing the priority pointer to advance and N+2 becomes the lowest priority request, and since the request at N+3 has not yet been serviced it becomes the new CURRENT POINTER.

In the case of a series of reads to the same queue, SKIP REQ may not be asserted while CURRENT REQ is asserted (i.e. a series of reads to “D” queue will have all SKIP REQ blocked by the first transaction that asserts BUSY[D]#). In this case, all pending requests have pre-charge penalties. The control logic can process internally generated refresh requests during this time, or the control logic can service requests using CURRENT REQ. These requests will have pre-charge penalties, since they are to the same DIMM/bank, but the control logic can determine if an alternative optimization (such as page-mode access) will optimize performance.

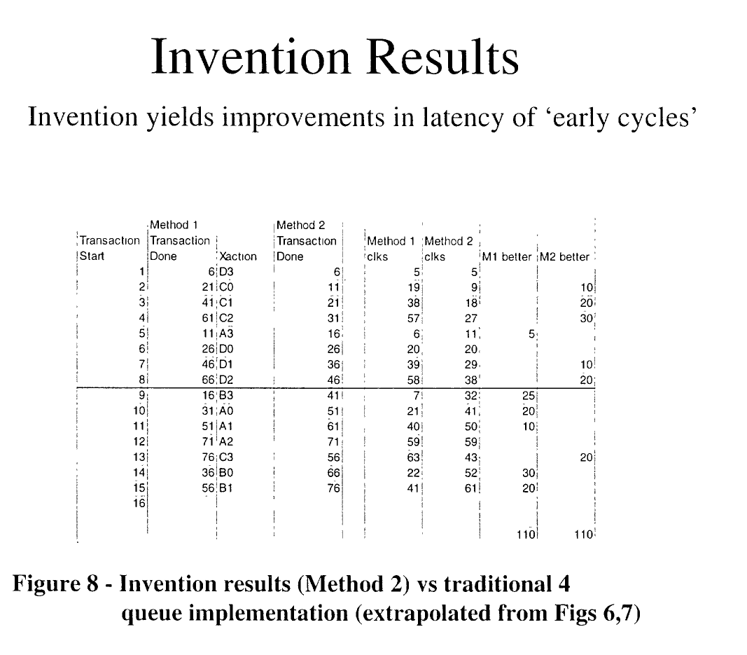

FIG. 8 is a tabulated result of an arbitrary set of transactions from FIGS. 6 and 7. Since for both cases full memory utilization is achieved, the total number of clocks needed to complete the transactions is the same. The result shows that the current embodiments perform better than the conventional approach at returning data in the time-order requested because the earlier transactions are given priority over the later transactions. In this arbitrary set of transactions the first 8 transactions are completed by the current embodiments at 85 clocks earlier than the traditional implementation. The benefit is that the CPUs have not been kept waiting for critical data, and may begin processing data earlier thereby increasing system performance.

There has been disclosed herein embodiments for improving the efficiency and reducing the latency in a multiprocessor system by performing the memory access method using “critical time ordering”. This gives earlier transactions priority over transactions received later in time. The “critical time ordering” provides for the selection of transactions so that memory bandwidth is maximized by selecting subsequent transactions. This minimizes lost bandwidth due to contention for memory resources (i.e. due to RAS pre-charge). Furthermore, the next transaction of those available is selected by selecting the transactions in their time-critical sequence.

Embodiments of the invention combines the use of a unified read request structure with pre-decoded bit fields and rotating priority encoders to deliver read requests to the arbiter that are critically time ordered (first-in-first-out) by using a buffer re-allocation mechanism that utilizes strict linear ordering. Hence, embodiments trade-off some “idle free-buffer time” in favor of using the buffer address as an efficient time-ordering mechanism.

An Alternative Embodiment

In an alternative embodiment, a control mechanism for increasing performance of memory accesses using a time-stamp reorder methodology that allows the memory controller arbitor to take into account time-of-arrival, and ‘urgency’ when reordering memory access requests to improve performance (lower latency increased throughput).

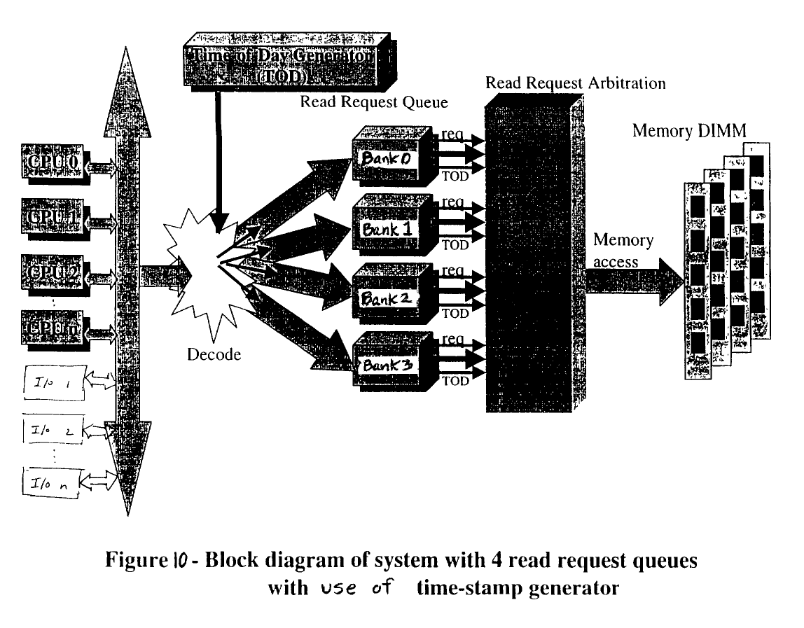

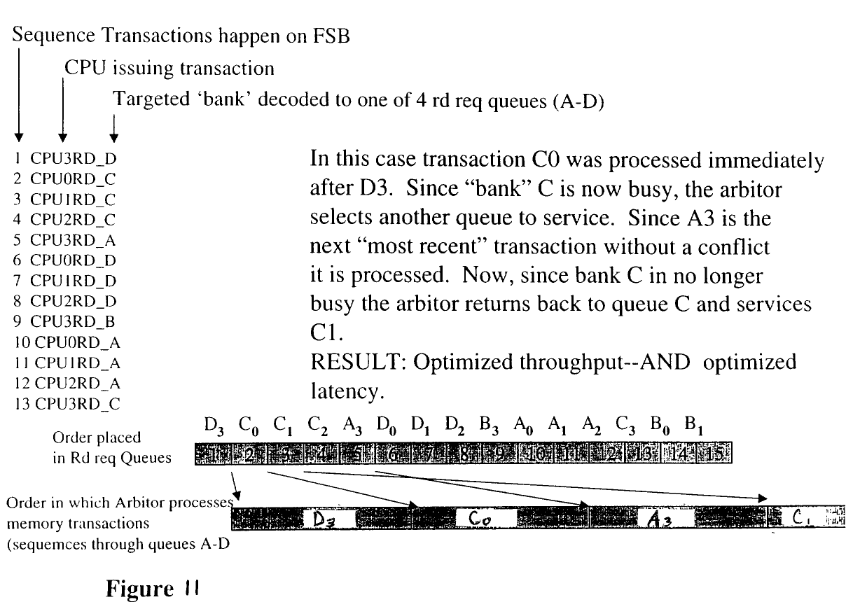

FIG. 10 is a block diagram of one embodiment of a system having four read request queues and a time stamp generator. As with FIG. 2, the number of read request queues may be greater or less than four. This embodiment uses an internal count value for “time-of-arrival” determination. Each incoming memory request is associated with the current count value at the time of arrival from the time-of-day (TOD) generator. This count value is propagated along with the memory request into the read request queue. The arbitor uses this information to decide if it should access the next sequential entry in the same queue or should continue on to the next queue. Since typically the order in which the queues are serviced is of no real concern, the arbitor can also use the timestamp to select the next queue to process. This provides a mechanism of improving the efficiency and reducing the latency in a multiprocessor system by dynamically improving the memory access using “critical time ordering” which gives accesses received first into the read requests queues priority over later arriving accesses. FIG. 11 illustrates a transaction processing sequence with the four read request queues and the time stamp generator.

The use of a time-of arrival counter, coupled with transaction counters for each buffer entry, allows the arbitor to process transaction in an order that is more intelligent and lowers latency by processing transactions in critical order (all other things being equal). The control within the arbitor uses the time-stamp to achieve the desired result can be implemented with a variety of algorithms. Though the memory bandwidth is improved for maximum throughput, the sequence in which incoming memory read transactions were processed was different. The use of the time stamp generator in the memory access system achieves a lower latency than the prior art. Depending on the ‘blocking factor’ of the CPUs, the advantages of this technique can have significant improvements in system performance.

In one embodiment, the time stamp generator uses an n-bit count value where the 2 bits are reserved for ‘day’ count of (0,1,2,3) and the remainder bits are equal to the maximum memory latency. Maximum memory latency is dependent on the implementation, but for example a 64 deep queue with maximum of 10 clocks per memory reference would result in 64×10=640 clks˜10 bit Time-of-day (TOD) count. It is possible to use a slower clock for the Time-of-day counters to reduce the number of bits needed. Note that in one embodiment each entry in the read request queue is accompanied by its respective time-stamp which increases the number of bits per entry. Increasing density makes this a practical implementation technique to gain additional performance.

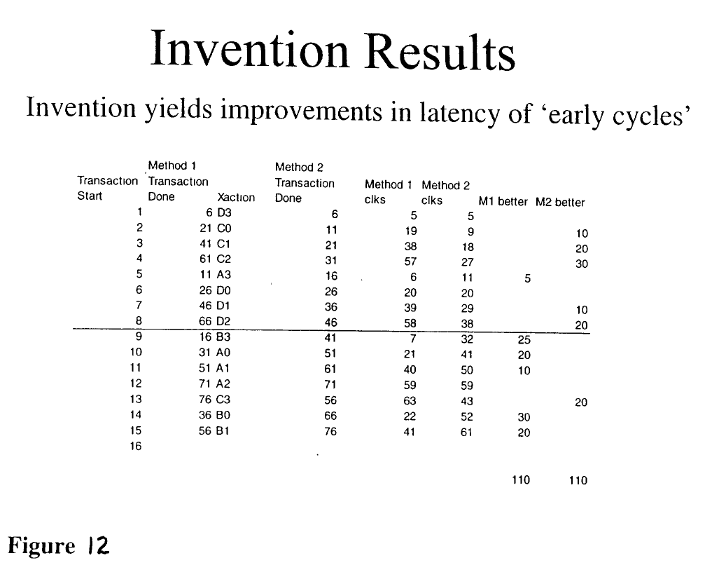

FIG. 12 illustrates results of use of the memory access system of FIG. 10.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. In other instances, well-known structures and functions were not described in elaborate detail in order to avoid obscuring the subject matter of the present invention. For example, the embodiments described above may be used in conjunction with other optimization techniques. Embodiments may also be modified to efficiently process only operations to a same bank. This may be realized by making a modification to FIG. 5 where all queues are blocked except a single bank, so as to allow processing of only those requests (i.e. if trying to process with page-open technique). Accordingly, the scope and spirit of the invention should be judged in terms of the claims which follow.

What is claimed is:

1. A system, comprising:
a read request buffer to receive and reorder memory access requests, the read request buffer reordering one request to skip a next request when the one request is to be delayed, and returning to the skipped request to process the request in a first-in first-out order;
a buffer allocator to supply buffer addresses for memory access requests; and
a control logic to control the reordering of the request.

2. The system of claim 1, wherein the read request buffer includes a current request encoder.

3. The system of claim 1, wherein the read request buffer includes a skip request encoder.

4. The system of claim 1, wherein the buffer allocator includes a buffer address assignment module to assign buffer addresses for memory access requests in a linear order.

5. The system of claim 4, wherein the control logic includes a processor to process the linearly-ordered buffer addresses.

6. The system of claim 1, further comprising:
a plurality of status bits to mark buffer addresses as busy when the addresses are written to and cleared at the completion of the memory access request.

7. The system of claim 1, further comprising:
a plurality of buffer decode bits to map buffer addresses and to reduce contention between buffers.

8. A system, comprising:
a request receiving module to receive request for memory access;
a unified read request buffer to reorder the received request when that request is to be skipped, and to return to process the skipped request in a first-in first-out order;
a buffer allocator to supply buffer addresses for the memory access request to assign buffer addresses for memory access requests in an order of receipt of the request; and
a control logic to control the processing of the buffer addresses.

9. The system of claim 8, wherein the read request buffer includes a plurality of buffer decode bits to map buffer addresses and to minimize contention between buffers.

10. The system of claim 9, further comprising a current request encoder to process the plurality of buffer decode bits for a current request.

11. The system of claim 9, further comprising a skip request encoder to process the plurality of buffer decode bits for skipped requests.

12. A method, comprising:
receiving and reordering requests for memory access to skip a request when that request is to be delayed; and
returning to the skipped request to process the request in a first-in first-out order.

13. The method of claim 12, further comprising:
assigning buffer addresses for memory access requests in a linear order to preserve a timing order of receipt of the requests.

14. The method of claim 13, further comprising:
using the linearly-ordered buffer addresses to determine a first-in priority order.

15. A computer readable medium containing executable instructions which, when executed in a processing system, causes the system to process memory access requests, comprising:
receiving and reordering requests for memory access to skip a request when that request is to be delayed; and
returning to the skipped request to process the request in a first-in first-out order.

16. The medium of claim 15, further comprising:
assigning buffer addresses for memory access requests in a linear order to preserve a timing order of receipt of the requests.

17. The medium of claim 16, further comprising:
using the linearly-ordered buffer addresses to determine a first-in priority order.
